(19) United States
(12) Patent Application Publication
(10) Pub. No.: US 2005/0216668 A1
(43) Pub. Date: Sep. 29, 2005

(54) Mode device, administrative server, routing method and authentication method

(75) Inventors: Ikuko Kobayashi, Kawasaki (JP); Shinji Kimura, Sagamihara (JP); Hirofumi Inomata, Tokyo (JP); Kokoro Kobayashi, Chiba (JP); Takeshi Miei, Tokyo (JP); Naoko Shigematsu, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Nippon Telegraph and Telephone Corporation, Tokyo (JP)

(21) Appl. No.: 10/960,416

(22) Filed: Oct. 6, 2004

(30) Foreign Application Priority Data
Mar. 29, 2004 (JP) 2004-094915

(51) Int. Cl. G06F 12/00

(52) U.S. Cl. 711/118; 711/103

(57) ABSTRACT

A diskless computer is allowed to finish a write request with no influence of a storage device and a network of the storage device. A node device 104 passes on information sent and received between a diskless computer 101 and a storage device 102. When information sent from the diskless computer 101 is a write request to the storage device 102, target data of the write request is cached, and a response to the write request is sent to a source diskless computer of the write request. The write request for the data having been cached is sent to a storage device into which the data is written, and a response to the write request is received from the storage device.

This application relates to and claims priority from Japanese Patent Application, No. 2004-094915 filed on Mar. 29, 2004, the contents of which are incorporated herein by reference.

### BACKGROUND OF THE INVENTION

The present invention relates to a technique which routes a write request sent from a diskless computer to a storage device.

IP-SAN (Internet Protocol-Storage Area Network) is a technique that uses protocols such as iSCSI (Small Computer Systems Interface protocol over the Internet) to implement data transfer at the block level in IP networks. Furthermore, the diskless computer is a computer that dose not have a direct attached storage (DAS) such as a hard disk drive, or a computer that does not use a DAS. As a diskless computer system using IP-SAN, there is Cisco Network Boot, Cisco Systems Inc. (Cisco Network Boot Installation and Configuration Guide [online], Cisco Systems, searched on 1 Dec., 2003, <URL:http://www.cisco.com/japanese/warp/public/3/jp/service/manual_j/rt/5000/cnbicg/>).

Cisco Network Boot is a product that allows a diskless computer to boot an OS (Operating System). The components of the diskless computer system required for this product are a diskless computer, a DHCP (Dynamic Host Configuration Protocol)/TFTP (Trivial File Transfer Protocol) server, a storage router, a storage device connected to the storage router with a fibre channel, and an IP network interconnected to the diskless computer, the DHCP/TFTP server and the storage router.

In Cisco Network Boot, the following tasks are performed beforehand: to store a boot image of the diskless computer in a volume provided by the storage device connected to the storage router; to allocate a LUN (Logical Unit Number) to this volume, to allocate an iSCSI target name (iSCSI name) to the storage device that provides the volume to register it to the storage router; and to register boot information of the diskless computer (including the LUN of the volume where the boot image of the diskless computer is stored, the iSCSI target name, and the IP address of the storage router) to the DHCP/TFTP server.

After these tasks are finished, when the diskless computer is powered ON, the diskless computer initiates BIOS, and starts a PXE (Preboot execution Environment) program in accordance with the BIOS. By this PXE program, the diskless computer first obtains from the DHCP server an IP address that the diskless computer has to use, the IP address of the TFTP server, a boot loader program name, the IP address of the storage router, the LUN of the volume where the boot image of the diskless computer is stored, and the iSCSI target name of the storage device that provides the volume. Then, a boot loader is downloaded from the TFTP server to start. By this boot loader, the diskless computer loads the OS from the volume where the boot image of the iSCSI target is stored and starts it. Moreover, it starts an iSCSI driver to have the application ready for execution.

By the OS and the iSCSI driver, the diskless computer sends a disk access request to the storage device connected to the storage router, the disk access request is associated with starting the application, data read, and data write.

### SUMMARY OF THE INVENTION

Consider the case where a diskless computer is connected to a WAN through a router and a storage device is connected to the WAN through a storage router in the diskless computer system. In this case, a write request for a data block issued by the diskless computer is sent to the storage router through the router and the WAN. Then, this write request is sent from the storage router to the storage device, and executed by the storage device.

In the meantime, in the diskless computer system of the configuration above, a high-speed LAN with a low network failure rate can generally be used for connecting between the diskless computer and the router. However, the WAN connecting between the router and the storage router has higher traffic at lower speed than that of the LAN. Furthermore, network failure tends to occur as well. On this account, in the diskless computer system of the configuration above, the processing time for the write request issued by the diskless computer depends on the performance of the WAN, and it affects data processing in the diskless computer. Moreover, when failure occurs in the WAN, the write request cannot be finished and it is also likely to abnormally terminate data processing.

The present invention has been made in view of the circumstances above. An object of the present invention is to allow the diskless computer to finish the write request with no influence of the storage device or the network of the storage device.

In order to solve the problem above, in one of the aspects of the present invention, a node device which passes on information sent and received between a diskless computer and a storage device is disposed, a write request sent from the diskless computer is cached, and the write end is sent to a source of the request without waiting for write processing in accordance with a request of the storage device. Furthermore, the cached write request is sent to the storage device, the write end is received from the destination of the request, and thus the process of the cached write request is ended.

For example, the node device according to the present invention is a node device which passes on information sent and received between at least one diskless computer and at least one storage device, the node device including:
a cache means which caches target data of a write request, and sends a response to the write request to a source diskless computer of the write request when information sent from the diskless computer is the write request to a storage device; and
a flash means which sends the write request for the data having been cached in the cache means to a storage device into which the data is written, and receives a response to the write request from the storage device.

Here, the node device may manage the load state of the network between the node device and the storage device, the load state of the storage device, whether to allow connection to the storage device (the state whether to allow connection or not), and the cached data volume at each volume of the storage device. It may stop the transmission of the write request to the volume of the storage device to which connection is not allowed until it can be connected. It may suppress the transmission of the write request to the volume of the storage device that its load exceeds a specified value. Moreover, it may delay a response of write end to the diskless computer and may suppress the issuance of the write request, when the cached data volume exceeds a default value.

Further, the node device may have a means which logs the sequential write requests and the update records of data of a file system into a recording medium, a means which manages logs at each volume of the storage device, and a means which creates a write request to the volume of the storage device from the logs. When the node device is abnormally terminated, it may read out log information after a restart and the transmission of the write request to the volume of the storage device is allowed to start again.

In another aspect of the present invention, an administrative server which determines whether a user of a diskless computer is allowed to use a storage device through the node device above is provided. In determining whether to allow or not, when the user of the diskless computer has used the storage device through the node device, a write request for data to be written into the storage device among data cached in the node device is created and sent.

For example, the administrative server according to the invention is an administrative server which determines whether a user of a diskless computer is allowed to use a storage device through the node device above, the administrative server including:
an administrative information storing means which stores, at each of users, authentication information about the user, identification information about a storage device available for the user, and user management information including identification information about a node device used by the user of the diskless computer when the user has used the storage device; and
a user authentication means which authenticates the user of the diskless computer by searching for the user management information including the user authentication information contained in a user authentication request received from the diskless computer through the node device, in the administrative information storing means,
wherein in the case where user management information including user authentication information that is contained in the user authentication request is stored in the administrative information storing means and node device identification information is contained in the user management information, the user authentication means allows the node device which is specified by the node device identification information to send a write request for data to be written into a storage device specified by storage device identification information of the user management information being cached in the node device, and updates node device identification information of the user management information to identification information of the node device having passed on the user authentication request.

### BRIEF DESCRIPTION OF THE DRAWINGS

The teachings of the invention can be readily understood by considering the following detailed description in conjunction with the accompanying drawings, in which:

FIG. 1 is a schematic diagram illustrating a diskless computer system to which a first embodiment according to the present invention is applied;

FIG. 2 is a diagram for describing the outline of the operation of the diskless computer system to which the first embodiment according to the present invention is applied;

FIG. 3 is a schematic diagram illustrating anode device 104;

FIG. 4 is a diagram for describing the module configuration of a write cache program 120;

FIG. 5A is a diagram illustrating the exemplary configuration of session management information 210;

FIG. 5B is a diagram illustrating the exemplary configuration of target management information 220;

FIG. 6 is a diagram illustrating the exemplary configuration of a cache record 230 for a data block to be cached in a main memory 112 by a CPU 111 in accordance with the write cache program 120;

FIG. 7 is a schematic diagram illustrating a user management server 106;

FIG. 8 is a diagram illustrating the exemplary configuration of user management information 240;

FIG. 9A is a diagram illustrating the operational flow of a user authentication process in a diskless computer 101;

FIG. 9B is a diagram illustrating the operational flow of a user authentication process in the node device 104;

FIG. 9C is a diagram illustrating the operational flow of a user authentication process in the user management server 106;

FIG. 10A is a diagram illustrating the operational flow of an iSCSI session connecting process in the diskless computer 101;

FIG. 10B is a diagram illustrating the operational flow of an iSCSI session connecting process in the node device 104;

FIG. 11A is a diagram illustrating the operational flow of a data caching process in the diskless computer 101;

FIG. 11B is a diagram illustrating the operational flow of a data caching process in the node device 104;

FIG. 12 is a diagram illustrating the operational flow of a data flash process in the node device 104;

FIG. 13 is a diagram illustrating the operational flow of an iSCSI session disconnecting process in the node device 104;

FIG. 14 is a diagram illustrating the exemplary configuration of a log record 250 used in a modified example of the first embodiment according to the present invention;

FIG. 15 is a diagram illustrating the exemplary configuration of a program started by a diskless computer 101 of a second embodiment according to the present invention;

FIG. 16 is a diagram illustrating the exemplary configuration of session management information 210 used in the second embodiment according to the present invention;

FIG. 17 is a diagram for describing the module configuration of a write cache program 120 started by a node device 104 of the second embodiment according to the present invention; and

FIG. 18 is a diagram illustrating the exemplary configuration of a log record 260 created by a CPU 111 in accordance with a journaling file module 126 in the second embodiment according to the present invention.

### DETAILED DESCRIPTION OF THE PREFERRED EMBODIMENTS

Hereinafter, embodiments according to the present invention will be described, taking an example that IP is used as a network communication protocol between the diskless computer and the storage router and iSCSI is used for the upper protocol of the network communication protocol.

### First Embodiment

A diskless computer system to which a first embodiment according to the present invention is applied will be described with reference to the drawings.

(1) System Configuration

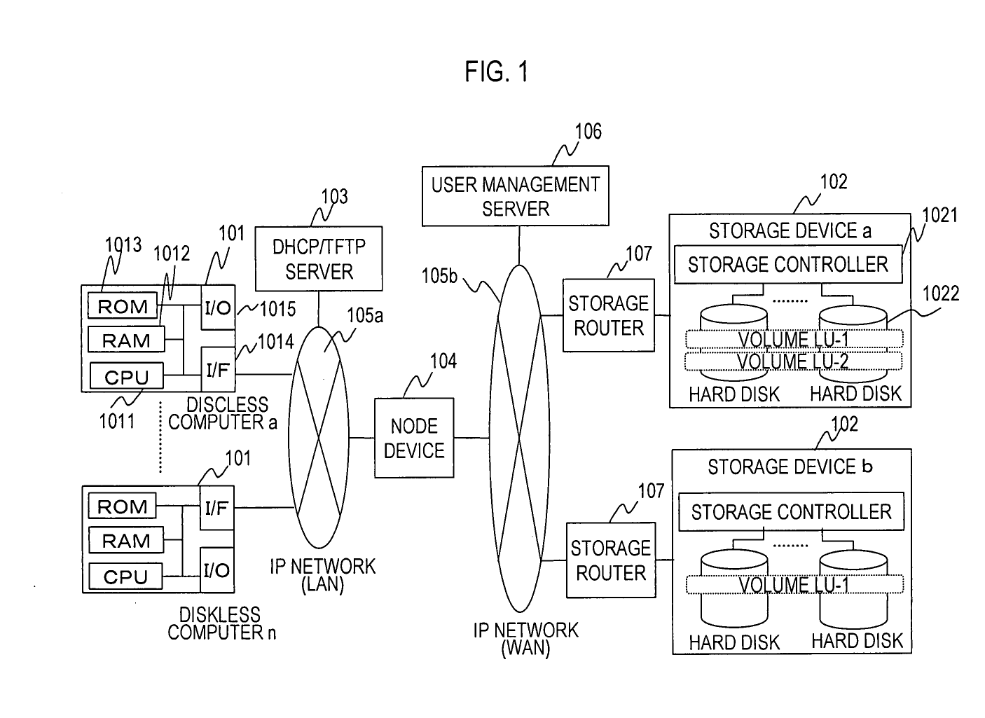

FIG. 1 is a schematic diagram illustrating the diskless computer system to which the first embodiment according to the present invention is applied. As shown in the drawing, the diskless computer system of the embodiment has at least one diskless computer 101, at least one storage device 102, a DHCP/TFTP server 103, a node device 104, a user management server 106, and a storage router 107. Here, the diskless computer 101 is connected to an IP network 105a such as a LAN. The storage device 102 is connected to an IP network 105b such as a WAN through the storage router 107. The IP network 105a is connected to the IP network 105b through the node device 104.

The IP network is not defined (limited) about the physical configuration (including copper wires and optical fibers) when it is a communication network using IP. Besides, in FIG. 1, although the DHCP/TFTP server 103 is connected to the IP network 105a and the user management server 106 is connected to the IP network 105b, it is fine to arrange them at places where they can communicate with the diskless computer 101.

The diskless computer 101 has the same function as that of the diskless computer described in the background art. That is, the diskless computer 101 has a CPU 1011, a RAM 1012 which functions as a work area for the CPU, a ROM 1013 which stores BIOS and PXE programs therein, an interface (for example, NIC: Network Interface Card) 1014 which connects to the IP network 105a, and an I/O 1015 which connects to an input and output control unit. The CPU 1011 starts the PXE program to obtain a boot loader program from the DHCP/TFTP server 103. Then, it starts this boot loader program to load an OS from the storage device 102 and start it. Here, the OS started in the diskless computer 101 is incorporated with a driver (hereinafter, it is called an iSCSI driver) that can process an iSCSI protocol (particularly, an iSCSI initiator protocol). The iSCSI driver is implemented by a program, hardware for exclusive use, or the combination thereof.

The storage device 102 provides a volume to the diskless computer 101. Here, the volume is a logical storage area configured by at least one hard disk 1022. As a specific example of the storage device 102, a RAID unit having a plurality of hard disks 101. As shown in the drawing, the storage device 102 has a storage controller 1021 and at least one hard disk 1022. The storage controller 1021 is connected to the storage router 107 through a fibre channel, for example. Then, it controls data transfer to the volume in accordance with a command (a command such as a fibre channel protocol) sent from the storage router 107.

The storage router 107 performs a conversion process between the iSCSI protocol and a protocol (for example, a fibre channel protocol) adopted by the storage device 102. Accordingly, the command of the iSCSI protocol issued by the diskless computer 101 is converted to the command of the protocol adopted by the storage device 102, and sent to the storage device 102. Furthermore, the response data of the command sent from the storage device 102 is converted to the response data of the iSCSI protocol, and sent to the diskless computer 101.

In addition, when the storage device 102 has an interface for the iSCSI protocol, that is, it is an iSCSI supported storage device that can directly execute the command of the iSCSI protocol issued by the diskless computer 101, the storage router 107 is unnecessary. In this case, the storage device 102 is connected to the IP network 105b.

The node device 104 is a router device having a function that caches a write request. The node device 104 analyzes the iSCSI command stored in a packet received from the diskless computer 101, caches the iSCSI command when it is a write request, and sends a packet having the response data of write end stored therein to the source of the packet. Furthermore, it sends a packet having the cached iSCSI command stored therein to the IP network 105b, receives a packet having the response data of write end stored therein from the destination (iSCSI target) of the packet, and then ends the process of the cached iSCSI command. Moreover, when the data stored in the packet having been received from the diskless computer 101 is not the iSCSI command of write request, the node device routes the packet in accordance with the destination of this packet as similar to the general router devices.

The DHCP/TFTP server 103 has the same function as that of the DHCP/TFTP server described in the background art. More specifically, it has the function that distributes the boot loader program to an inquired diskless computer 101 in addition to the IP address that the diskless computer has to use. Additionally, in FIG. 1, the DHCP/TFTP server 103 is represented by a single apparatus. However, the DHCP server and the TFTP server actually have different IP addresses. Then, hereinafter, the DHCP/TFTP server 103 will be described separately as the DHCP server 103a or the TFTP server 103b as required.

The user management server 106 is a computer having a function that manages the correspondence between a user and a volume of the storage device 102 usable by that user and authorizes the user to use the diskless computer system. In the diskless computer system of the embodiment, a user ID and a password are assigned to the user. Moreover, a volume is allocated to the user, and a boot image is stored in this volume.

(2) Outline of the System Operation

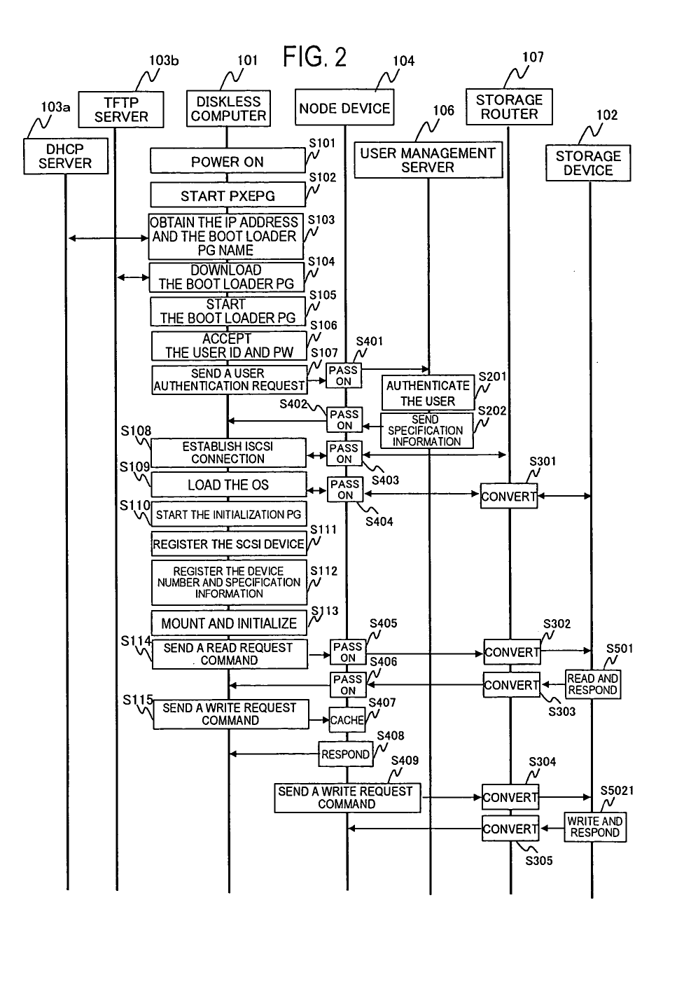

The outline of the operation of the diskless computer system shown in FIG. 1 will be described. FIG. 2 is a diagram for describing the outline of the operation of the diskless computer system to which the first embodiment according to the present invention is applied.

First, when a user terns ON the power of a given diskless computer 101 (S101), the CPU 1011 loads the BIOS and PXE programs stored in the ROM 1013 to initiate the BIOS, and starts the PXE program in accordance with the BIOS in the diskless computer 101 (S102). By the PXE program, the CPU 1011 makes access to the DHCP server 103a where the IP address is specified by the PXE program through the interface 1014, and obtains the IP address to be used by the diskless computer 101, the IP address of the TFTP server 103b, the boot loader program name, the IP address of the node device 104, and the IP address of the user management server 106 (S103). Subsequently, the CPU 1011 makes access to the TFTP server 103b with the IP address obtained from the DHCP server 103a through the interface 1014, and downloads a boot loader program with the boot loader program name obtained from the DHCP server 103a (S104). Then, it starts the boot loader program (S105).

By the boot loader program, the CPU 1011 outputs a message to a display unit connected to the diskless computer 101, and requests to input the user ID and the password. Subsequently, when the CPU 1011 accepts the user ID and the password from the user through the input control unit connected to the diskless computer 101 (S106), it creates a user authentication request that includes the user ID and the password accepted and has the IP address of the user management server 106 for destination having been accepted from the DHCP server 103a, and sends the request to the IP network 105a through the interface 1014 (S107). This user authentication request is sent to the user management server 106 through the node device 104 (S401).

When the user management server 106 receives the user authentication request, it authenticates the user by using the user ID and the password included in the request (S201). When the user is authenticated, the server sends specific information (the IP address of the storage router, the iSCSI target name, the port number of the volume, and a LUN) which specifies the volume of the storage device 102 to be used by the user to the source of the user authentication request (S202). This specific information is notified to the diskless computer 101 (boot loader program) through the node device 104 (S402). Moreover, when the user is not authenticated, the server processes the error, such as sending an error message to the diskless computer 101.

Subsequently, when the CPU 1011 obtains the specific information from the user management server 106 through the interface 1014 in the diskless computer 101, it establishes an iSCSI session with the storage router 107 connected to the storage device 102 with the iSCSI target name specified by the specific information (S108) through the node device 104 (S403) in accordance with the boot loader program. Then, it loads the OS from the volume with the LUN specified by the specific information (S109) through the node device 104 and the storage router 107 (S404 and S301). The CPU 1011 starts an initialization program of the loaded OS (S110). By this initialization program, the CPU 1011 starts the iSCSI driver incorporated in the OS, and registers it as an SCSI device in a device file held by the diskless computer 101 (S111). Then, by the iSCSI driver, the CPU 1011 registers the device number allocated to the iSCSI driver by the OS and the specific information (the IP address of the storage router, the iSCSI target name, the port number of the volume, and the LUN) obtained from the user management server 106 into the OS management domain (S112). Then, by the initialization program, the CPU 1011 mounts the rout of a file system on the SCSI device (that is, one of the volumes provided by the storage device 102), sequentially reads out and starts programs registered in the file system, and executes initialization (S113).

In the meantime, in the diskless computer 101, when the iSCSI driver receives a read request for a data block by an application, the CPU loll creates a read request command of the iSCSI protocol, and sends it to the iSCSI target of the established iSCSI session (S114). This read request command is stored in a packet, outputted from the interface 1014, and sent to the storage router 107 through the node device 104 (S405). Then, it is converted to the command of a protocol adopted by the storage device 102 in the storage router 107 (S302), and then sent to the storage device 102.

In the storage device 102, when the storage controller 1021 receives the read request, it reads a data block out of the volume with the LUN specified by the read request, and sends the response data including this to the source diskless computer 101 (the iSCSI driver) of the read request (S501). This response data is converted to the response data format of the iSCSI program in the storage router 107 (S303), and then sent to the diskless computer 101 through the node device 104 (S406). In the diskless computer 101, when the CPU 1011 receives the response data of the read request from the iSCSI target, it delivers the data block included in the response data to the application of the source of the read request in accordance with the iSCSI driver.

In the diskless computer 101, when the iSCSI driver receives a write request for a data block by the application, the CPU 1011 creates a write request command of the iSCSI protocol, and sends it to the iSCSI target of the established iSCSI session (S115). This write request command is stored in a packet, outputted from the interface 1014, and sent to the node device 104.

The node device 104 analyzes data stored in a packet sent from the IP network 105a. Then, when the data is not the iSCSI command of write request, the node device routes this packet in accordance with the destination of this packet as similar to the general routers (S401 to S406). On the other hand, when the data is the iSCSI command of write request, the node device caches it (S407). Moreover, the node device sends a packet having the response data of write end stored therein to the source of that packet (S408). In the diskless computer 101, when the CPU 1011 receives the response data of write request from the iSCSI target, it delivers the processed result included in the response data to the application of the source of the write request in accordance with the iSCSI driver.

Additionally, the node device 104 sends a packet having the iSCSI command of the cached write request stored therein to the IP network 105b (S409). This write request command is converted to a command of a protocol adopted by the storage device 102 in the storage router 107 (S304), and sent to the storage device 102.

In the storage device 102, when the storage controller 1021 receives the write request, it writes the data block included in the write request into the volume with the LUN specified by the write request, and sends the response data to the source of the write request (S502). This response data is converted to the response data format of the iSCSI program in the storage router 107 (S305), and then sent to the node device 104.

(3) Node Device

Next, the details of the node device 104 will be described.

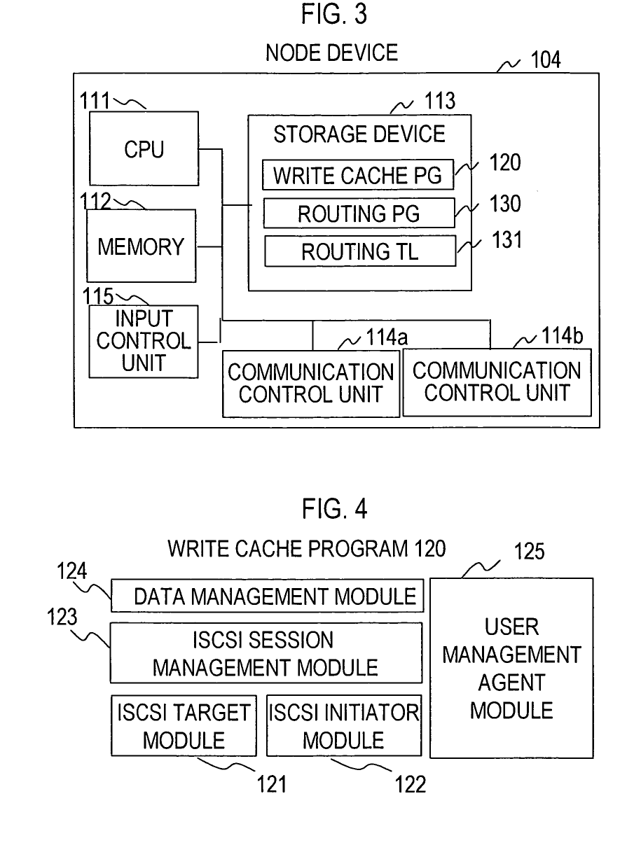

FIG. 3 is a schematic diagram illustrating the node device 104. As shown in the drawing, the node device 104 has a CPU 111, a main memory 112 which functions as the work area for the CPU 111, a storage unit (recording medium) 113, a communication control unit 114a which connects to the IP network 105a, a communication control unit 114b which connects to the IP network 105b, and an input control unit 115.

The storage unit 113 has a write cache program (PG) 120, a routing program 130, and a routing table (TL) 131.

The CPU 111 executes the routing program 130 to route the packet by using the routing table 131. Accordingly, the packet received by the communication control unit 114a or the communication control unit 114b is outputted from any one of the communication control unit 114a and the communication control unit 114b in accordance with the destination. However, when the destination of the packet is the node device 104, the packet is delivered to any one of an iSCSI target module 121, an iSCSI initiator module 122, a data management module 124, and a user management agent module 125 in the write cache program 120, which will be described later, according to the port number of the packet. Then, the packets received from the iSCSI target module 121, the iSCSI initiator module 122, the data management module 124, and the user management agent module 125 are routed and outputted from any one of the communication control unit 114a and the communication control unit 114b.

The CPU 111 executes the write cache program 120, and then processes the iSCSI protocol and caching the write request of iSCSI.

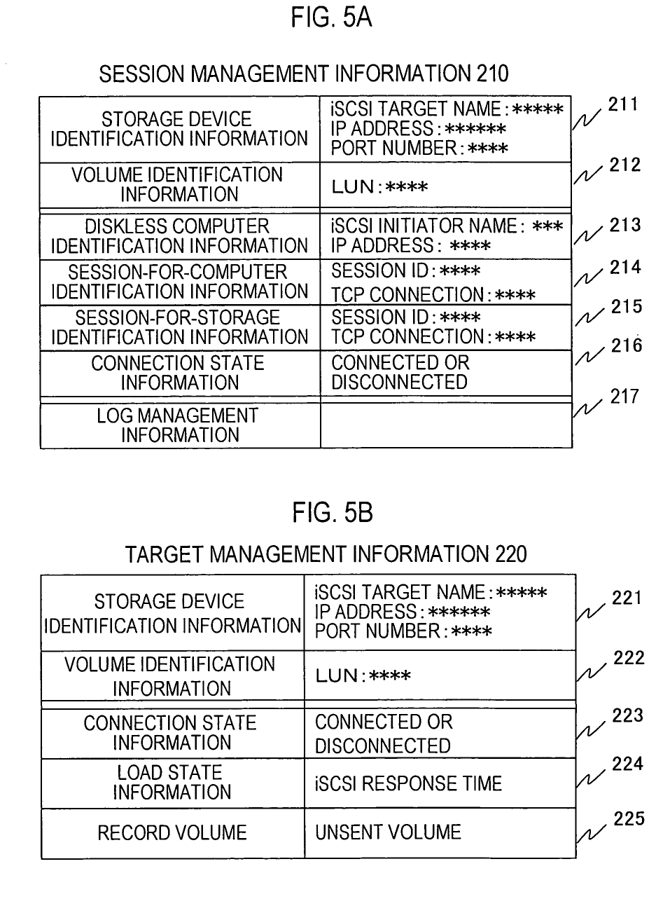

FIG. 4 is a diagram for describing the module configuration of the write cache program 120. As shown in the drawing, it has the iSCSI target module 121, the iSCSI initiator module 122, an iSCSI session management module 123, the data management module 124, and the user management agent module 125.

The iSCSI target module 121 allows the CPU 111 to process the protocol of the iSCSI target, in which the CPU receives the packet of the iSCSI command and sends the packet of iSCSI response data to the iSCSI initiator (the diskless computer 101).

The iSCSI initiator module 122 allows the CPU 111 to process the protocol of the iSCSI initiator, in which the CPU sends the packet of the iSCSI command to the iSCSI target (the storage device 102) and receives the packet of iSCSI response data from the iSCSI target.

The iSCSI session management module 123 allows the CPU 111 to perform the process of managing connection information (iSCSI session) between the iSCSI initiator (the diskless computer 101) of the iSCSI target module 121 and the iSCSI target (the storage device 102) of the iSCSI initiator module 122, the load state of the storage device 102, the connection state, and the cached data volume.

The data management module 124 allows the CPU 111 to perform the process of caching the data block and requesting data block write to the storage device 102.

The user management agent module 125 allows the CPU 111 to perform the process of communicating the location (the IP address) of the node device 104 to the user management server 106, obtaining information about the storage device 102 from the user management server 106, and executing a data flash request sent from the user management server 106.

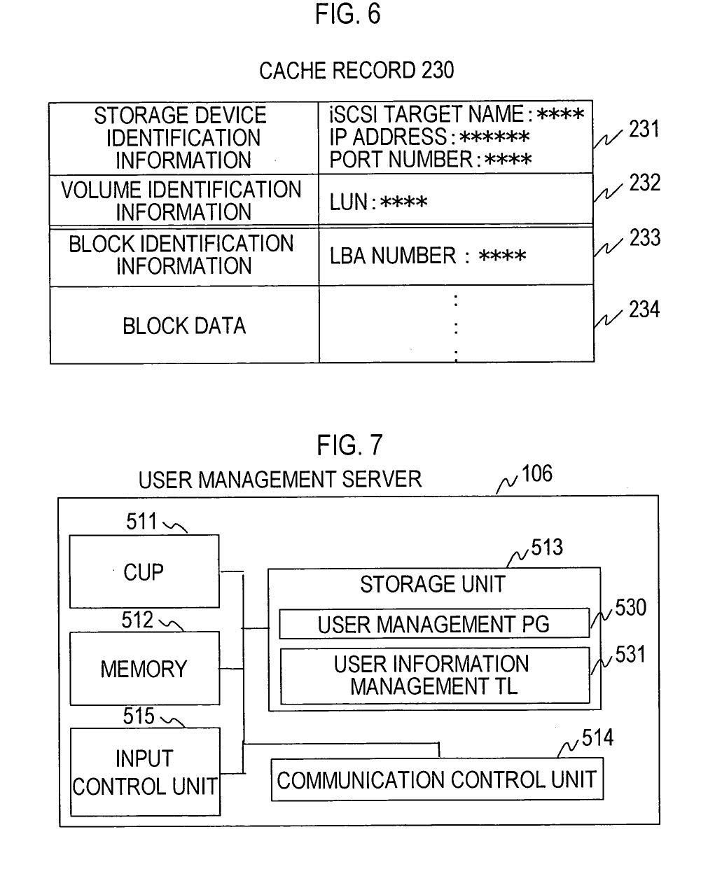

FIGS. 5A and 5B are diagrams illustrating the exemplary configuration of administrative information used by the CPU 111 for processing in accordance with the write cache program 120. FIG. 5A is the exemplary configuration of session management information 210, and FIG. 5B is the exemplary configuration of target management information 220. These pieces of the management information 210 and 220 are data stored in the main memory 112.

The session management information 210 is information that manages the iSCSI session between the diskless computer 101 and the storage device 102. As shown in FIG. 5A, it has storage device identification information 211, volume identification information 212, diskless computer identification information 213, session-for-computer identification information 214, session-for-storage identification information 215, connection state information 216, and log management information 217. In addition, the log management information 217 is information for use in a modified example of the embodiment, described later.

The storage device identification information 211 includes the iSCSI target name of the storage device 102, and the IP address and the port number used by the iSCSI target. The volume identification information 212 includes the LUN of the volume specified by the storage device identification information 211. The diskless computer identification information 213 includes the iSCSI initiator name (iSCSI name) of the iSCSI driver of the diskless computer 101 and the IP address used by the iSCSI initiator. The session-for-computer identification information 214 is information that discriminates the iSCSI session between the iSCSI initiator of the diskless computer 101 and the node device 104, including the session ID and TCP connection information. The session-for-storage identification information 215 is information that discriminates the iSCSI session between the node device 104 and the iSCSI target of the storage device 102, including the session ID and TCP connection information. The connection state information 216 is information that represents the connection state of the iSCSI session between the iSCSI initiator of the diskless computer 101 and the node device 104, having any one of being connected and disconnected registered.

The target management information 220 is information that manages the load and connection states of the storage device 102, having storage device identification information 221, volume identification information 222, connection state information 223, load state information 224, and a record volume 225 as shown in FIG. 5B.

The storage device identification information 221 and the volume identification information 222 are the same information as that of the session management information 210. The connection state information 216 is information that represents the connection state of the iSCSI session between the node device 104 and the iSCSI target of the storage device 102, having anyone of being connected and disconnected registered. The load state information 224 is information that represents the load state of the iSCSI session between the node device 104 and the iSCSI target of the storage device 102, such as the iSCSI response time. The record volume 225 is information that represents a capacity of data blocks which are not sent to the storage device 102 (the volume), such as the number of records cached.

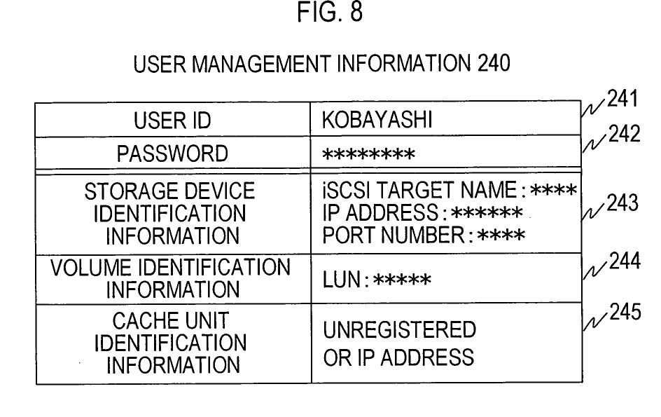

FIG. 6 is a diagram illustrating the exemplary configuration of a cache record 230 of a data block cached in the main memory 112 by the CPU 111 in accordance with the write cache program 120. Here, the cache record 230 is a record unit of the data block. As shown in the drawing, it has storage device identification information 231, volume identification information 232, block identification information 233, and block data 234.

The storage device identification information 231 and the volume identification information 232 are information that discriminates the session management information 210 which is used for transmitting data blocks, and are the same information as that of the session management information 210. The block information 233 is information that represents the location of a data block in the volume and is the LBA (Logical Block Address) number, for example. The block data 234 is data to be written into the volume.

(4) User Management Server

Next, the details of the user management server 106 will be described.

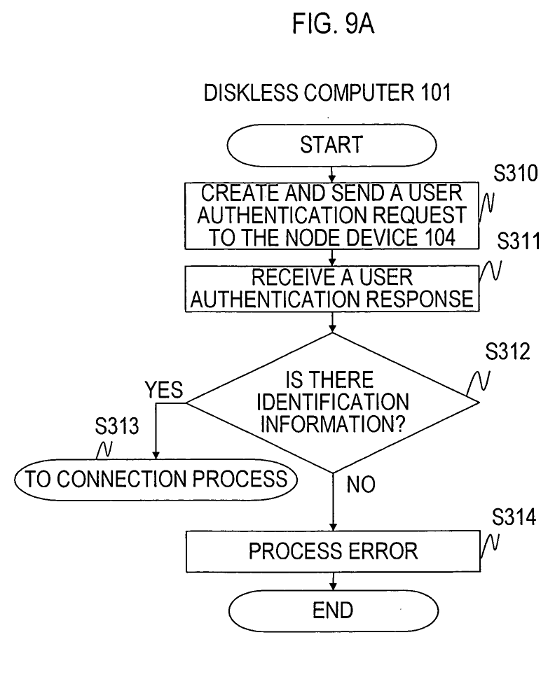

FIG. 7 is a schematic diagram illustrating the user management server 106. As shown in the drawing, the user management server 106 has a CPU 511, a main memory 512 which functions as the work area for the CPU 511, a storage unit 513, a communication control unit 514 which connects to the IP network 105b, and an input control unit 515.

The storage unit 513 has a user management program 530, and a user information management table 531.

The CPU 531 executes the user management program 530, and thus it performs the process in which it uses the user information management table 531 to authenticate a user of a diskless computer 101 and allows the user to use the diskless computer system when booting the diskless computer 101.

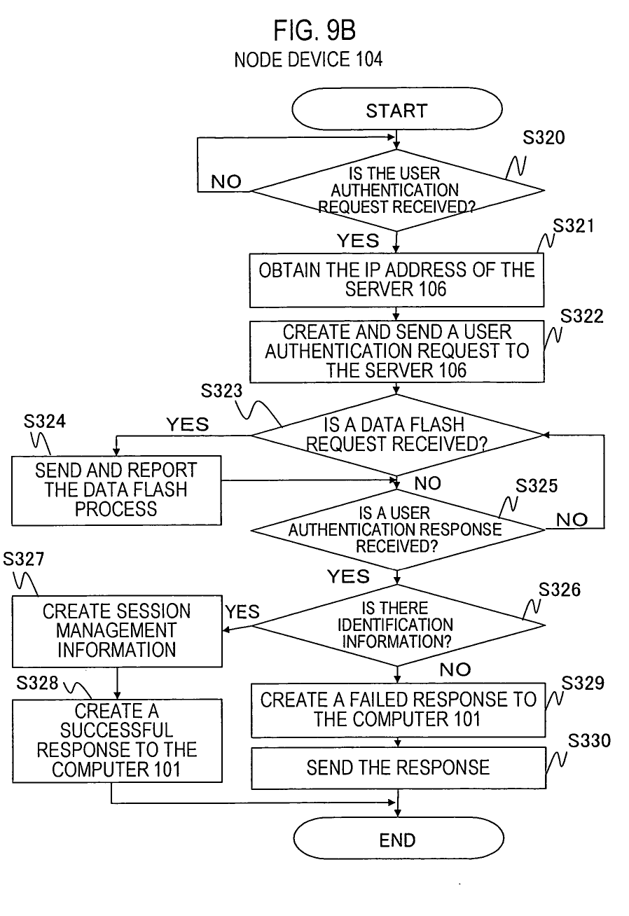

Into the user information management table 531, user management information 240 which is required to authenticate users and to specify the volumes allocated to the users at each of the users is registered. FIG. 8 is a diagram illustrating the exemplary configuration of the user management information 240. As shown in the drawing, the user management information 240 has a user ID 241, a password 242, storage device identification information 243, volume identification information 244, and cache unit identification information 245.

The user ID 241 and the password 242 are information that determines whether to allow a user to use the diskless computer system. The storage device identification information 243 and the volume identification information 244 are information that specifies the volume allocated to the user and is the same information as that of the session management information 210. The cache unit identification information 244 is identification information of the node device 104 that is used by the iSCSI driver of the diskless computer 101 to connect to the storage device 102 and is the IP address, for example. When the iSCSI driver of the diskless computer 101 is not connected to the storage device 102, NULL information that represents this event is set.

(5) System Setup Work

The system setup work (prerequisite tasks) which is performed to allow a system administrator to put on the state where the diskless computer system of the embodiment can be used will be described as the work separated into the setup work for the storage device/the storage router, the setup work for the user management server, the setup work for the DHCP/TFTP server, and the setup work for the node device.

(5-1) Setup Work for the Storage Device/the Storage Router

First, the input control unit connected to the storage device 102 is used to create at least one volume in the storage device 102, and the LUN (LU-0 and LU-1 in the example shown in FIG. 1) is assigned to each of the created volumes. Furthermore, various drivers including the OS and the iSCSI driver, and the boot image including applications are installed in the created volume.

Subsequently, the iSCSI target name and the port number are allocated to the storage device 102. The iSCSI target name and the port number allocated to the storage device 102 and the LUN of the volume are registered into a storage router 107 used by the storage device 102 along with the IP address of the storage router 107, by using the input control unit connected to the storage router 107 in accordance with the device specifications.

(5-2) Setup Work for the User Management Server

First, the user ID and the password are assigned to each of the users of the diskless computer system. Furthermore, the volume of the storage device 102 to be allocated to each of the users is determined.

Subsequently, the input control unit 515 of the user management server 106 is used to register the user management information 240 of each of the users into the user information management table 531. More specifically, the following is registered: the user ID and the password (the user ID 241 and the password 242) assigned to the user, the LUN of the volume (the volume identification information 244) allocated to the user, the iSCSI target name and the port number of the storage device 102 which provides the volume, and the IP address (the storage device identification information 243) of the storage router 107 used by the storage device 102. In addition, the cache unit identification information 245 of the node device 104 is NULL at this stage.

Then, the user management program 530 is started.

(5-3) Setup Work for DHCP/TFTP Server

First, an IP address is allocated to each of the diskless computers 101.

Subsequently, the input control unit connected to the DHCP server 103a is used to register the IP address allocated to each of the diskless computers 101, the IP address of the TFTP server 103b, the boot loader program name, the IP address of the node device 104, and the IP address of the user management server 106 into the DHCP server 103a. Furthermore, the input control unit connected to the TFTP server 103b is used to register the boot loader program into the TFTP server 103b.

Then, the DHCP server program of the DHCP server 103a is started, and the TFTP server program of the TFTP server 103b is started.

Moreover, the boot loader program for use in the diskless computer system of the embodiment has the function of authenticating users and obtaining the volume information of the storage device 102, and the function of processing the iSCSI initiator protocol which loads the OS from the volume of the storage device 102.

(5-4) Setup Work for the Node Device

The input control unit 115 of the node device 104 is used to start the write cache program 120 and the routing program 130.

(6) Details of the System Operation

After finishing the system setup work in (5), the diskless computer 101 is powered ON, and then the operation described in the outline of the system operation in (2) is started. Here, in the operation described in (2), the details of the user authentication process (corresponding to S107, S401, S201 and S202 in FIG. 2), the iSCSI session connecting process (corresponding to S108 and S402 in FIG. 2), and the data block write process (corresponding to S115, S406, S407, S408, S304, S502 and S305 in FIG. 2) will be described. In addition, although it is not described in (2), the iSCSI session disconnecting process by terminating the OS of the diskless computer 101 will be described as well.

(6-1) User Authentication Process

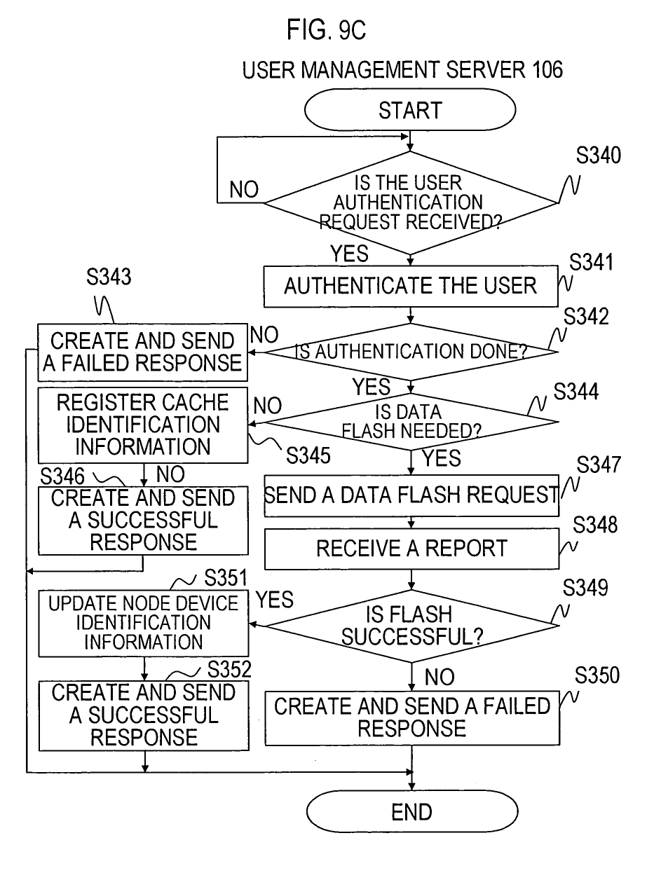

FIGS. 9A, 9B and 9C are flow charts for describing the user authentication process. FIG. 9A depicts the operational flow of the user authentication process in the diskless computer 101, FIG. 9B depicts the operational flow of the user authentication process in the node device 104, and FIG. 9C depicts the operational flow of the user authentication process in the user management server 106.

As shown in FIG. 9A, in the diskless computer 101, the CPU 1011 creates a user authentication request packet including the user ID and the password obtained from the user and the IP address of the user management server 106 in accordance with the boot loader program, and sends it to the node device 104 (S310).

After that, the CPU 1011 waits for a user authentication response packet to be sent from the node device 104 (S311). When the received user authentication response packet stores the storage device identification information 243 and the volume identification information 244 therein (YES at S312), the CPU performs the iSCSI session connecting process to the storage device 102 (S313). On the other hand, when the information is not stored (NO in S312), the CPU outputs error information to the output control unit connected to the I/O 1015 and ends the process (S314).

As shown in FIG. 9B, in the node device 104, when the CPU 111 receives the user authentication request packet from the diskless computer 101 through the communication control unit 114a in accordance with the routing program 130 (S320), it processes the user authentication request packet in accordance with the user management agent 125. More specifically, the CPU 111 obtains the IP address of the user management server 106 from the user authentication request packet (S321). Then, it newly creates a user authentication request packet including the user ID and the password contained in the received user authentication request where the source is the IP address of the node device 104 and the destination is the IP address of the user management server 106. Subsequently, the CPU 111 sends the newly created user authentication request packet to the user management server 106 through the communication control unit 114b in accordance with the routing program 130 (S322).

After that, when the CPU 111 receives a data flash request packet from the user management server 106 through the communication control unit 114b in accordance with the routing program 130 (S323), performs a data flash process in accordance with the data management module 124, and creates a report packet showing whether the process is successful or not. Here, the data flash process is the process in which data blocks stored in all the cache records 230 having the storage device identification information 231 and the volume identification 232 specified by the data flash request packet cached in the node device 104 is written into the volume of the storage device 102 specified by the storage device identification information 231 and the volume identification 232. The details of the data flash process will be described later. Subsequently, the CPU 111 sends the report packet to the user management server 106 through the communication control unit 114b in accordance with the routing program 130 (S324).

When the CPU 111 receives a user authentication response packet from the user management server 106 through the communication control unit 114b in accordance with the routing program 130 (S325), it processes the user authentication response packet in accordance with the user management agent 125. More specifically, the CPU 111 checks whether the storage device identification information 243 and the volume identification information 244 are stored in the user authentication response packet (S326).

When it determines that the information is stored at S326, it newly creates session management information 210, and registers the storage device identification information 243 and the volume identification 244 stored in the user authentication packet into the storage device identification information 211 and the volume identification information 212 of the session management information 210 (S327). In addition, the diskless computer identification information 213, the session-for-computer identification information 214, the session-for-storage identification information 215, and the connection state information 216 are NULL at this step. Then, the CPU newly creates a user authentication response packet including the storage device identification information 243 and the volume identification information 244 where the source is the node device 104 and the destination is the diskless computer 101 that is the source of the user authentication request packet (S328). On the other hand, when the CPU determines that the information is not stored at S326, it newly creates a user authentication response packet showing that the connection is not allowed, where the source is the node device 104 and the destination is the diskless computer 101 that is the source of the user authentication request packet (S329).

The CPU 111 sends the newly created user authentication response packet to the diskless computer 101 through the communication control unit 114a in accordance with the routing program 130 (S330).

As shown in FIG. 9C, in the user management server 106, when the CPU 511 receives the user authentication request packet from the node device 104 through the communication control unit 514 (S340), it authenticates the user in accordance with the user management program 530 (S341). More specifically, The CPU checks whether the user management information 240 with the user ID and the password included in the user authentication request packet is registered into the user information management table 531. When the user management information 240 like this is not registered (NO at S342), the CPU determines that the user is not authenticated, creates a user authentication response packet that stores the message showing this event, and sends it to the node device 104 (S343). On the other hand, when the user management information 240 like this is registered (YES at S342), the CPU determines that the user is authenticated. In this case, the CPU 511 checks whether the IP address is set in the cache unit identification information 245 of the user management information 240, and thus it determines whether to need the data flash process (S344).

When the IP address is not set at S344, the user of the diskless computer 101 is the user who uses the diskless computer system of the embodiment first time, and thus the data block for this user is not cached in the node device 104. Therefore, the CPU 511 does not request the data flash process to the node device 104. In this case, the CPU 511 registers the IP address of the node device 104 that is the source of the user authentication request packet into the cache unit identification information 245 of the user management information 240 registered into the user information management table 531 (S345). Then, the CPU 511 creates a user authentication response packet including the storage device identification information 243 and the volume identification information 244 of the user management information 240, and sends it to the node device 104 that is the source of the user authentication request through the communication control unit 514 (S346).

On the other hand, when the IP address is set at S344, the user of the diskless computer 101 is the user who already has used the diskless computer system of the embodiment, and thus the data block of this user is likely to be cached in the node device 104. Therefore, the CPU 511 sends a data flash process request packet to the node device 104 with the IP address registered into the cache unit identification information 245 of the user management information 240 (S347). Then it waits for the arrival of a report packet from the node device 104 (S348). Subsequently, when the receives report packet shows that the data flash process is failed (NO at S349), the CPU 511 creates a user authentication response packet showing that the connection is not allowed, and sends it to the node device 104 that is the source of the user authentication request through the communication control unit 514 (S350). On the other hand, when the received report packet shows that the data flash process is successful (Yes at S349), the CPU updates the IP address of the cache unit identification information 245 of the user management information 240 registered into the user information management table 531 to the IP address of the node device 104 that is the source of the user authentication request packet (S351). Then, the CPU 511 creates a user authentication response packet including the storage device identification information 243 and the volume identification information 244 of the user management information 240, and sends it to the node device 104 that is the source of the user authentication request through the communication control unit 514 (S352).

(6-2) iSCSI Session Connecting Process

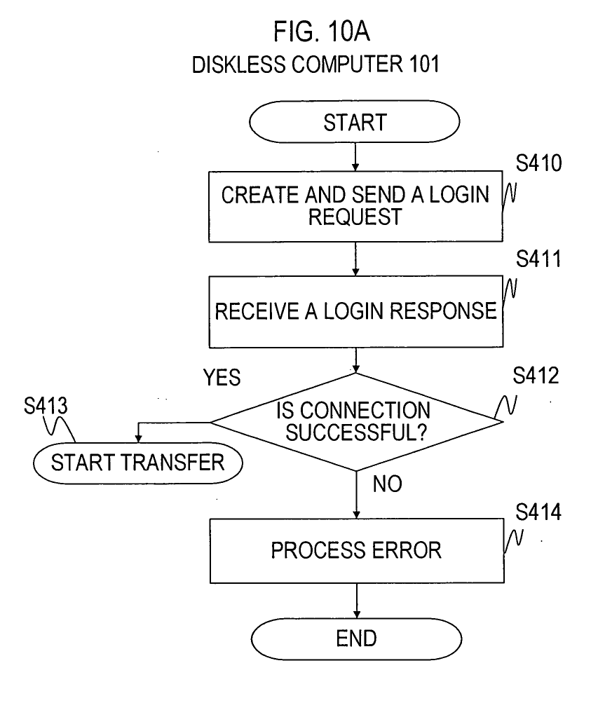

FIGS. 10A and 10B are flow charts for describing the iSCSI session connecting process. FIG. 10A depicts the operational flow of the iSCSI session connecting process in the diskless computer 101, and FIG. 10B depicts the operational flow of the iSCSI session connecting process in the node device 104. In addition, the operational flow of the iSCSI session connecting process in the storage router 107 and the storage device 102 is the same as that of the existing storage router and the storage device, thus omitting the detailed description.

As shown in FIG. 10A, in the diskless computer 101, the CPU 1011 creates an iSCSI login request packet including the iSCSI initiator name, and the iSCSI target name of the storage device identification information 243 obtained from the user management server 106 in the user authentication process in (6-1) in accordance with the iSCSI driver, and sends it to the node device 104 (S410).

After that, the CPU 1011 waits for an iSCSI login response packet to be sent from the node device 104 (S411). Then, when the received iSCSI login response packet shows that the connection is successful (YES at S412), the CPU subsequently starts data transfer by using this iSCSI session (S413). On the other hand, when it shows that the connection is failed (NO at S412), the CPU outputs error information to the output control unit connected to the I/O 1015 and ends the process (S414).

As shown in FIG. 10B, in the node device 104, when the CPU 111 receives the iSCSI login request packet from the diskless computer 101 through the communication control unit 114a in accordance with the routing program 130 (S420), it processes the iSCSI login request packet in accordance with the iSCSI target module 121 and the iSCSI session management module 123. More specifically, the CPU 111 first creates a session ID and obtains the TCP connection information used for transmitting the iSCSI log in request packet in accordance with the iSCSI target module 121 (S421). Subsequently, the CPU 111 checks whether the session management information 210 with the iSCSI target name included in the iSCSI login request packet is registered into the main memory 112 in accordance with the iSCSI session management module 123 (S422). Moreover, when it is registered, the CPU further checks whether the diskless computer identification information 213 of the session management information 210 is NULL (S423).

When it is determined that the session management information 210 with the iSCSI target name included in the iSCSI login request packet is not registered into the main memory 112 at S422, or that the diskless computer identification information 213 of the session management information 210 is not NULL (the iSCSI initiator name and the IP address are already registered) at S423, the CPU 111 determines that the login request is not allowed (write cache is not allowed). Then, it creates an iSCSI login response packet showing that login is failed in accordance with the iSCSI target module 121. Subsequently, the CPU 111 sends the iSCSI login response packet to the diskless computer 101 mounted with the iSCSI initiator (the iSCSI driver) specified by the iSCSI login request packet having been received at S420 through the communication control unit 114a in accordance with the routing program 130 (S424).

On the other hand, when it is determined that the session management information 210 with the iSCSI target name included in the iSCSI login request packet is not registered into the main memory 112 at S422 and that the diskless computer identification information 213 of the session management information 210 is NULL at S423, the CPU 111 determines that the login request is allowed (write cache is allowed). Then, the CPU newly creates an iSCSI login request packet including the iSCSI target name of the storage device identification information 211 of the session management information 210 in accordance with the iSCSI initiator module 122. Moreover, it starts to measure the response time for the iSCSI login request packet. Subsequently, the CPU 111 sends the iSCSI login request packet to the storage router 107 connected to the iSCSI target (the storage device 102) through the communication control unit 114b in accordance with the routing program 130 (S425).

After that, when the CPU 111 receives an iSCSI login response packet from the storage router 107 through the communication control unit 114b in accordance with the routing program 130 (S426), it processes the iSCSI login response packet in accordance with the iSCSI initiator module 122 and the iSCSI session management module 123. More specifically, the CPU 111 first creates a session ID and obtains the TCP connection information used for transmitting the iSCSI login response packet in accordance with the iSCSI initiator module 121. Furthermore, it obtains the response time for the iSCSI log in request packet (S427). Subsequently, the CPU 111 confirms the iSCSI login response packet showing whether login is successful in accordance with the iSCSI session management module 123 (S428).

When it shows that login is failed at S428, the CPU 111 creates an iSCSI login response packet showing that login is failed in accordance with the iSCSI target module 121. Then, the CPU 111 sends the iSCSI login response packet to the diskless computer 101 mounted with the iSCSI initiator (the iSCSI driver) specified by the iSCSI log in request packet having been received at S420 through the communication control unit 114a in accordance with the routing program 130 (S429).

On the other hand, when it shows that log in is successful at S428, the CPU 111 updates the session management information 210 with the iSCSI target name included in the iSCSI login request packet having been received at S420 in accordance with the iSCSI session management module 123 (S430). More specifically, the CPU sets the iSCSI initiator name specified by the iSCSI login request packet having been received at S420 to the diskless computer identification information 213, the session ID and the TCP connection information created and obtained at S421 to the session-for-computer identification information 214, the session ID and the TCP connection information created and obtained at S427 to the session-for-storage identification information 215, and ‘being connected’ to the connection state information 216. Moreover, the CPU 111 newly creates target management information 220 in accordance with the iSCSI session management module 123, and registers the storage device identification information 211 of the updated session management information 210 into the storage device identification information 221, the volume identification information 212 of the updated session management information 210 into the volume identification information 222, ‘being connected’ into the connection state information 223, and the response time measured at S427 into the load state information 224 (S431). Subsequently, the CPU 111 creates an iSCSI login response packet showing that login is successful in accordance with the iSCSI target module 121. Then, the CPU 111 sends the iSCSI log in response packet to the diskless computer 101 mounted with the iSCSI initiator (the iSCSI driver) specified by the iSCSI log in request packet having been received at S420 through the communication control unit 114a in accordance with the routing program 130 (S432).

After that, the CPU 111 starts to monitor the iSCSI session established with the storage router 107 connected to the iSCSI target (the storage device 102) in accordance with the iSCSI initiator module 122 (S433). Then, when it detects that the iSCSI session is disconnected to the storage device 102 because of network disconnection, the CPU 111 changes the connection state information 223 of the target management information 220 about the iSCSI target to ‘being disconnected’ in accordance with the iSCSI session management module 123 (S434). Subsequently, it returns to S425 in order to again send the iSCSI login request packet to restart the session.

(6-3) Data Block Write Process

The data block write process can be separated into the data caching process in which the target data block of the write request is cached in the node device 104 (corresponding to S115, S407 and S408 in FIG. 2), and the data flash process in which the data block cached in the node device 104 is written into the storage device 102 (corresponding to S409, S304, S502 and S305 in FIG. 2). Hereinafter, the processes will be described.

(6-3-1) Data Caching Process

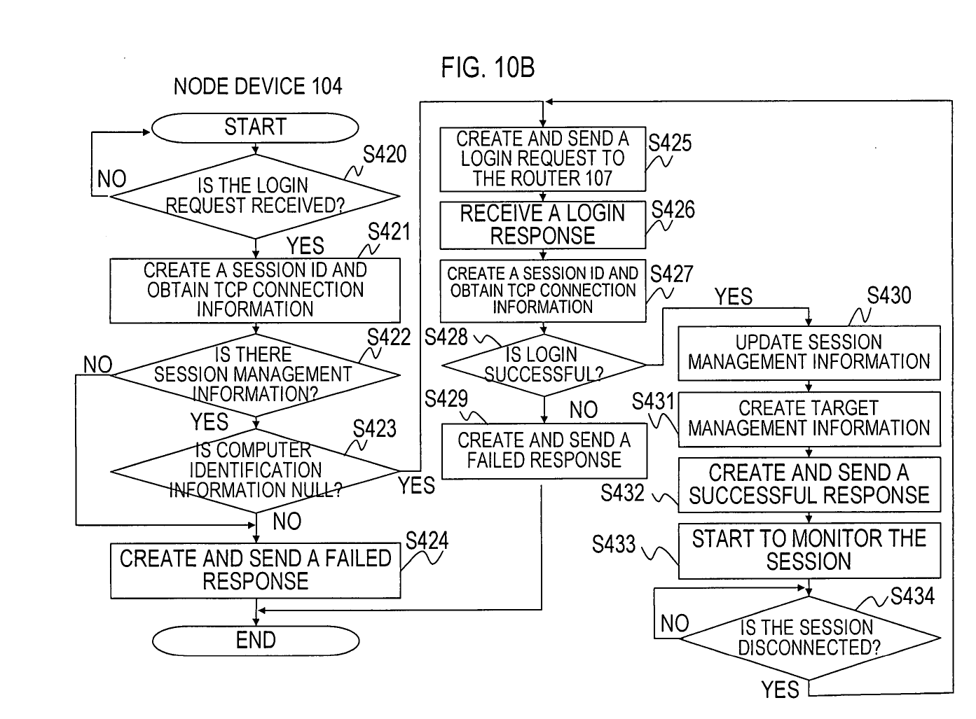

FIGS. 11A and 11B are flow charts for describing the data caching process. FIG. 11A depicts the operational flow of the data caching process in the diskless computer 101, and FIG. 11B depicts the operational flow of the data caching process in the node device 104.

As shown in FIG. 11A, in the diskless computer 101, the CPU 1011 creates an iSCSI write request packet including the iSCSI initiator name of the diskless computer itself and the iSCSI target name of the storage device 102, and sends it to the node device 104 in accordance with the iSCSI driver (S510). In addition, the iSCSI write request packet includes the LUN of the volume, the start LBA number, the number of data blocks, and the target data block of the write request.

After that, the CPU 1011 waits for an iSCSI write response packet to be sent from the node device 104 (S511). Then, when the received iSCSI write response packet shows that write is finished (YES at 512), the CPU ends the write process. On the other hand, the packet shows that write is failed (NO at S512), the CPU outputs error information to the output control unit connected to the I/O 1015 (S513), and ends the process.

As shown in FIG. 11B, in the node device 104, when the CPU 111 receives the iSCSI write request packet from the diskless computer 101 through the communication control unit 114a in accordance with the routing program 130 (S520), it processes the iSCSI write request packet in accordance with the iSCSI target module 121, the iSCSI session management module 123, and the data management module 124. More specifically, the CPU 111 first obtains the TCP connection information used for transmitting the iSCSI write request packet in accordance with the iSCSI target module 121. Subsequently, the CPU 111 selects the session management information 210 where the obtained TCP connection information is registered into the session-for-computer identification information in accordance with the iSCSI session management module 123 (S521). Then, the CPU 111 compares the number of blocks specified by the iSCSI write request packet with the remaining capacity of the main memory 112 in accordance with the data management module 124, and it determines whether the target data block of the write request stored in the iSCSI write request packet can be cached (S522).

When the remaining volume of the main memory 112 is smaller than the capacity that a given margin is added to the number of the target data blocks at S522, for example, the CPU determines that cache is impossible. Subsequently, the CPU 111 creates an iSCSI write response packet showing that write is failed in accordance with the iSCSI target module 121. Then, the CPU 111 sends the iSCSI write response packet to the diskless computer 101 mounted with the iSCSI initiator (the iSCSI driver) through the communication control unit 114a in accordance with the routing program 130 (S523).

On the other hand, when the remaining capacity of the main memory 112 is equal to or exceeds the capacity that a given margin is added to the number of the target data blocks at S522, for example, the CPU determines that cache is possible. Then, the CPU 111 secures the cache record area in the main memory 112. After that, it separates the target data block into record units, that is, units with a block size of 512 bytes, and obtains a plurality of block data. Then, the CPU creates the cache record 230 at each of the block data, and registers the storage device identification information 211 and the volume identification information 212 of the session management information 210 selected at S521 into the storage device identification information 231 and the volume identification information 232 of each of the cache records 230. Moreover, it registers the block data corresponding to the record 230 into the block data 234 of each of the cache records 230, and consecutive numbers from the start LBA number (=the start LBA number+the number of blocks from the starting block to the target block) into the block information 233 (S524). Subsequently, the CPU 111 selects the target management information 220 with the storage device identification information 211 and the volume identification information 212 of the session management information 210 having been selected at S521, and adds the total record number of the created cache records 230 to the record volume 225 of the target management information 220 (S525). After that, the CPU 111 creates an iSCSI write response packet showing that write is successful in accordance with the iSCSI target module 121. Then, the CPU 111 sends the iSCSI write response packet to the diskless computer 101 mounted with the iSCSI initiator (the iSCSI driver) through the communication control unit 114a in accordance with the routing program 130 (S526).

In addition, it is acceptable that the CPU 111 monitors the record volume 225 of the target management information 220 in accordance with the iSCSI session management module 123, and suspends the transmission of the iSCSI write response packet by the iSCSI target module 121 for a fixed time when the volume exceeds the threshold value. Since the diskless computer 101 cannot send the next write request when it does not receive the write response packet, the CPU can suppress the issuance of the write request by the diskless computer 101.

(6-3-2) Data Flash Process

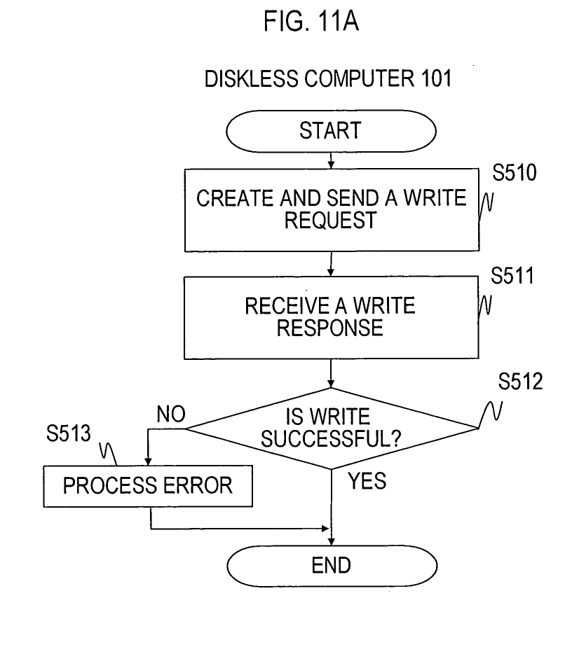

FIG. 12 depicts the operational flow of the data flash process in the node device 104. In addition, the operational flow of the data flash process in the storage router 107 and the storage device 102 is the same as the operational flow of the write request process in the existing storage router and the storage device. Then, the detailed description is omitted.

First, in the node device 104, the CPU 111 checks whether there is the target management information 220 where the connection state information 223 is ‘being connected’ and the record volume 225 exceeds a predetermined volume, or the target management information 220 where the connection state information 223 is ‘being connected’ and is over the data flash execution cycle time in accordance with the data management module 124 (S610). Here, to determine whether the data flash execution cycle time is over is done as follows. More specifically, the current data flash execution time for the volume of the storage device 102 specified by the target management information 220 is associated with the target management information 220. Furthermore, when the data flash process is not executed yet, the time to create the target management information 220 is associated as the current data flash execution time. Then, the elapsed time from the current data flash execution time to the present time is compared with the data flash execution cycle time, and then it is determined whether there is the target management information 220 over the data flash execution cycle time.

Then, when there is the target management information 220 where the record volume 225 exceeds a predetermined volume, or the target management information 220 over the data flash execution cycle time, the CPU 111 determines the volume of the storage device 102 specified by the target management information 220 as the target volume for the data flash process in accordance with the data management module 124 (S611). Moreover, the CPU determines the block data 234 stored in the cache record 230 with the storage device identification information 221 and the volume identification information 222 registered into the target management information 220 as the block data of the target for data flash (S612).

Subsequently, the CPU 111 restores data blocks as it connects the block data 234 of the target for data flash in order of the LBA number shown by the block information 233 in accordance with the data management module 124 (S613). Then, the CPU 111 specifies the session management information 210 with the storage device identification information and the volume identification information of the target volume in accordance with the iSCSI initiator module 122, and selects the iSCSI session specified by the session-for-storage identification information 215 of the session management information 210. Subsequently, it creates an iSCSI write request packet using the selected iSCSI session for writing the restored data block into the target volume. Furthermore, it starts to measure the response time for the iSCSI write request packet (S614). Then, the CPU 111 sends the iSCSI write request packet to the storage router 107 connected to the iSCSI target (the storage device 102) through the communication control unit 114b in accordance with the routing program 130 (S615).

After that, when the CPU 111 receives an iSCSI write response packet from the storage router 107 through the communication control unit 114b in accordance with the routing program 130 (S616), it processes the iSCSI write response packet in accordance with the iSCSI initiator module 122 and the data management module 124. More specifically, the CPU 111 first obtains the response time for the iSCSI write request packet in accordance with the iSCSI initiator module 121. Then, it registers the response time into the load state information 224 of the target management information 220 of the target volume in accordance with the data management module 124 (S617).

Subsequently, the CPU 111 confirms the iSCSI write response packet showing whether the write process is successful in accordance with the data management module 124 (S618).

When it is successful at S618, the CUP deletes the cache record 230 of the target block data (S619). Furthermore, it subtracts the total block number of the deleted target block data from the record volume registered into the target management information 220 of the target volume (S620). Moreover, when the target management information 220 of the target volume has the record volume of ‘zero’ and the connection state information 216 of the session management information 210 with the storage device identification information and the volume identification information of the target volume is ‘being disconnected’ (S621), the CPU deletes the target management information 220 (S622). Then, the CPU returns to S610. On the other hand, when it is failed at S618, the CPU does not process the deletion of the cache record 230 of the target block data, and returns to S610.

In addition, at S610, when the cache record having been cached reaches a fixed volume, or the load state information 224 of the target management information 220 exceeds a determined value, the CPU 111 ends the data flash process, and selects the writable volume of another storage device 102 in accordance with the data management module 124.

When the CPU 111 receives a data flash request packet from the user management server 106 through the communication control unit 114b in accordance with the routing program 130 (S630), it specifies the target management information 220 with the storage device identification information and the volume identification information specified by the data flash request packet in accordance with the user management agent module 125 (S631). Subsequently, the CPU 111 performs S611 to S621 to the specified target management information 220, and flashes all the cache records (S632). Then, the CPU 111 creates a report packet showing that the write process confirmed at S617 is successful or not in accordance with the user management agent module 125. The CPU 111 sends the report packet to the user management server 106 through the communication control unit 114b in accordance with the routing program 130 (S633).

(6-4) iSCSI Session Disconnecting Process

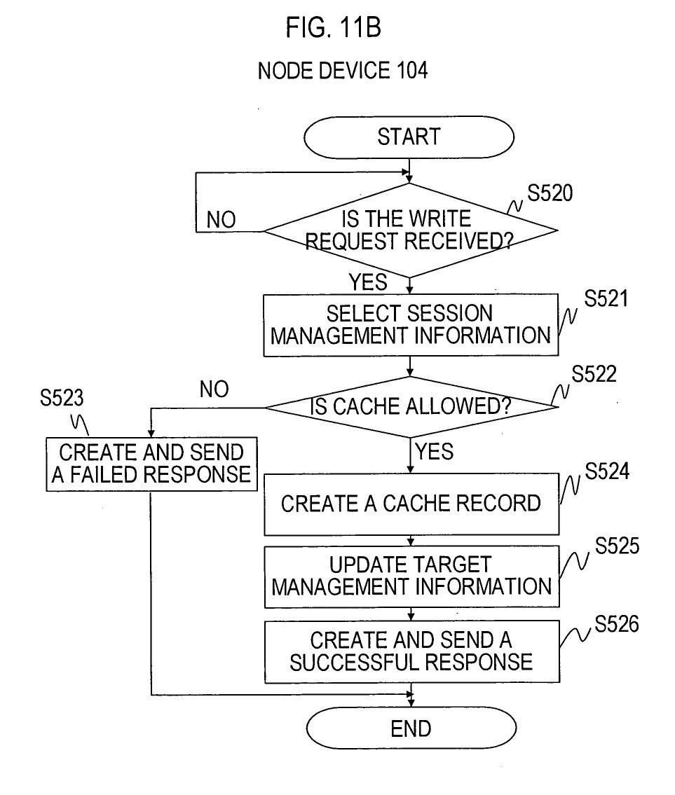

FIG. 13 depicts the operational flow of the iSCSI session disconnecting process in the node device 104. In addition, the operational flow of the iSCSI session disconnecting process in the diskless computer 101 is the same as the operational flow of the iSCSI session disconnecting process in the existing diskless computer. Thus, the detailed description is omitted.

In the node device 104, when the CPU 111 first receives an iSCSI logout request packet from the diskless computer 101 (the iSCSI driver) through the communication control unit 114a in accordance with the routing program 130 (S730), it processes the iSCSI logout request packet in accordance with the iSCSI target module 121 and the iSCSI session management module 123. More specifically, the CPU 111 obtains the TCP connection information used for transmitting the iSCSI logout request packet in accordance with the iSCSI target module 121 (S731). Then, the CPU 111 selects the session management information 210 with the session-for-computer identification information having the TCP connection information in accordance with the iSCSI session management module 123 (S732), and it changes the connection state information 216 to ‘being disconnected’ (S733). Subsequently, the CPU 111 creates an iSCSI logout response packet in accordance with the iSCSI target module 121. Then, the CPU 111 sends the response packet to the diskless computer 101 (the iSCSI driver) through the communication control unit 114a in accordance with the routing program 130 (S734).

When the CPU 111 detects the TCP connection where the disconnected state continues over a given time in accordance with the iSCSI target module 121 (S740), it selects the session management information 210 with the session-for-computer identification information having the TCP connection information about this event in accordance with the iSCSI session management module 123 (S741), and changes the connection state information 216 to ‘being disconnected’ (S742).

As described above, the first embodiment according to the present invention has been described.

In addition, in the embodiment, the example is taken and described that the session management information 210, the target management information 220, and the cache record 230 are stored in the memory 112 in the node device 104. However, these pieces of information can be stored in the storage unit 113 as well. In the case where the information is stored in the storage unit 113, the write process can be restarted when the write cache program 120 is abnormally terminated.

More specifically, in the case where the session management information 210, the target management information 220, and the cache record 230 are stored in the storage unit 113, the CPU 111 initializes the session management information 210 and the target management information 220 in accordance with the iSCSI session management module 123 when the write cache program 120 is started in the setup work for the node device in (5-4). Here, when the session management information 210 and the target management information 220 exist, the CPU determines that the write cache program 120 is abnormally terminated, changes the connection state information 216 and 223 of the session management information 210 and the target management information 220 to ‘being disconnected’, and sends the iSCSI login request packet to the storage device 102 in order to again connect to the volume of the storage device 102. Then, when the CPU receives the iSCSI login response packet showing that login is successful, it sets the TCP connection information and the response time to the target management information 220, and changes the connection state information 223 to ‘being connected’. Accordingly, the CPU 111 can read the data block not written out of the storage unit 113 in accordance with the data management module 124, and can restart the data flash process.

Furthermore, when the write cache program 120 is abnormally terminated, the iSCSI login request packet is sent from the iSCSI driver of the diskless computer 101. However, the CPU 111 selects the session management information 210 where the storage device identification information 211, the volume identification information 212, the diskless computer identification information 213, and the session-for-computer information 214 are matched in accordance with the iSCSI session management module 123, changes the connection state information 217 to ‘being connected’, and again sends the iSCSI login response packet. Therefore, the iSCSI session can be restarted.

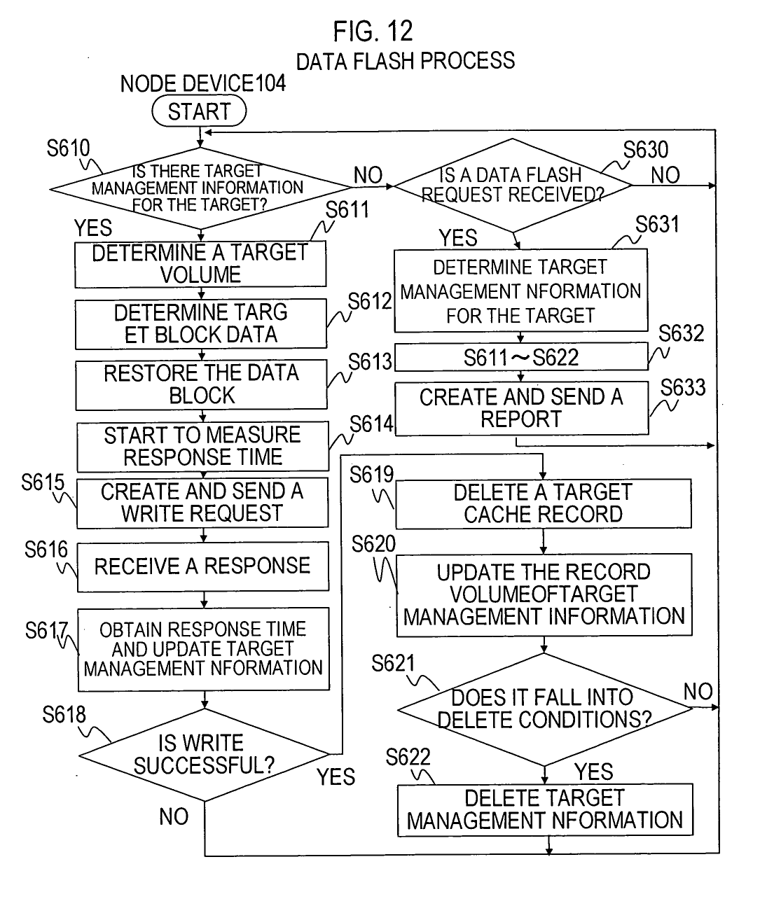

Moreover, in the embodiment, the cache record 230 is created as the block data having a block size of 512 bytes is a record unit. However, it is acceptable that a plurality of the block data sent by the write request can be cached in the memory 112 and/or the storage unit 113 as a single record unit. FIG. 14 shows the exemplary configuration of the record (called a log record) 250 when a plurality of the block data is a single record unit. As shown in the drawing, the log record 250 has block information 251, block number 252, and block data 253. The block information 251 is information that represents the location of the data block in the volume and is the LBA number. The block number 252 represents the number of data blocks recorded in the log record 250. The block data 253 is the data block formed of the block data having the number of blocks above.

When the log record 250 is used, the process is added at the step of updating the session management information 210 (S430 in FIG. 10B) in the iSCSI session connecting process in (6-2), in which the location to store the data block (a file) on the memory 112 and/or the storage unit 113 is secured and this is registered as the log management information 217 into the session management information 210 (see FIG. 5). Furthermore, at the step of creating the record of the data caching process in (6-3-1) (S524 in FIG. 11B), the log records 250 are sequentially registered into the location to store the data block specified by the log management information 217 of the corresponding session management information 210 in order of receiving the write iSCSI requests. Moreover, at the step of creating the iSCSI write request (S615 in FIG. 12) in the data flash process in (6-3-2), the iSCSI write request is created in order of the registered log records 250, and is sent to the volume of the storage device 102.

### Second Embodiment

A diskless computer system to which a second embodiment according to the present invention is applied will be described with reference to the drawings. In the embodiment, in a node device 104, a CPU 111 creates a record as an update record of data of a file system in accordance with a write cache program 120, and a data block is allowed to be written into the volume of a storage device 102 from the log record.

In the embodiment, it is a premise that an OS started by a diskless computer 101 supports a journaling file system. The journaling file system is the system that the meta contents of the file and the updated contents of data are recorded in a log and are periodically written into the actual data area based on this log. The journaling file system provides a means which indicates the file system to start logging (log starting means), and a means which records metadata and the change of the data block in a log file (log registration means) for the file system. By the journaling file system, the file system uses the log starting means to prepare log creation at the time of initialization, and uses the log registration means to create the log showing the updated contents when the write request occurs. At the step where the log is created, the write request of the file system ends. On the other hand, the journaling file system uses a means which writes the metadata recorded in the log and the update of the data block into the actual data area (log flash means), and periodically executes the write into the data area.

In the embodiment, the journaling file system is arranged on the node device 104. Then, to the diskless computer 101, an agent of the journaling file system which operates on the node device 104 is arranged with respect to the file system of an OS that operates on the diskless computer 101.

(1) Diskless Computer

In the diskless computer 101 of the embodiment, an agent program of the journaling file system is loaded from the volume that stores a boot image of a storage device 102 to the diskless computer 101 along with the OS and an iSCSI driver, and is executed by the CPU 1011.

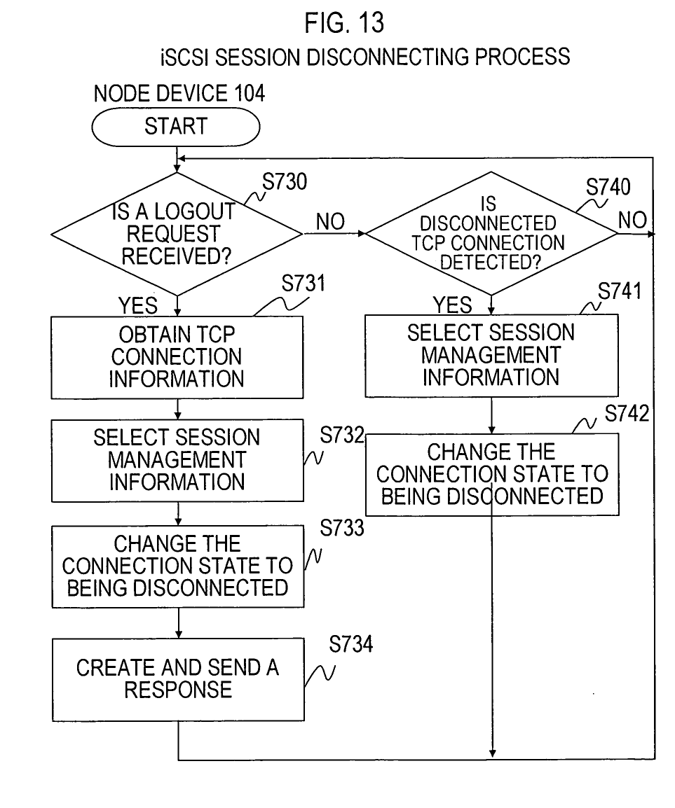

FIG. 15 is a diagram illustrating the exemplary configuration of a program that is started by the diskless computer 101 of the second embodiment according to the present invention. As shown in the drawing, the program has a file module 143 which is the file system, an iSCSI initiator module 141 which is the iSCSI driver, and a journaling agent module 142 which notifies a log starting request and a log registration request to the journaling file system. Furthermore, not shown in the drawing, an application module which requests to process data with respect to the file system and a communication module Which communicates with an IP network 105a are included as the other programs.

In the diskless computer 101, when the CPU 1011 creates a read request in accordance with the file module 143, it processes the read request in accordance with the iSCSI initiator module 141. More specifically, it creates an iSCSI read request packet in association with the read request from the file module 143, and sends it to the node device 104. Then, the CPU receives an iSCSI read response packet, and reads a data block out of the volume of the storage device 102. On the other hand, when the CPU 1011 creates a write request in accordance with the file module 143, it processes the write request in accordance with the log registration means provided by the journaling file system for the file system and the journaling agent module 142. More specifically, the log of the updated contents of the write request is created in accordance with the log registration means. Then, the CPU sends a registration request of this log to the journaling file system of the node device 104 in accordance with the journaling agent module 142, and receives the result.

(2) Node Device

The node device 104 in the embodiment is different from the first embodiment in the configuration of session management information 210 and the module configuration of a write cache program 120.

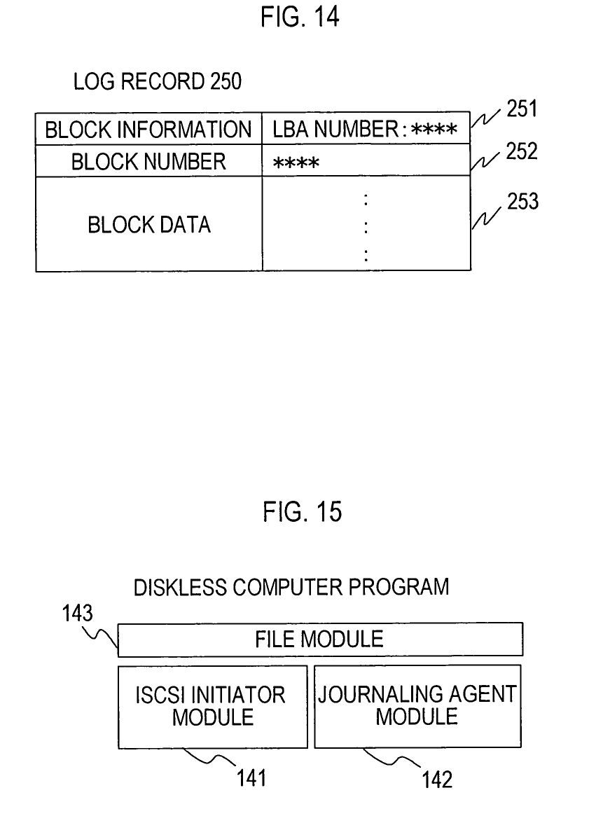

FIG. 16 is a diagram illustrating the exemplary configuration of the session management information 210 for use in the second embodiment according to the present invention. As shown in the drawing, in the embodiment, agent identification information 218 is added to the session management information 210. The agent identification information 218 is information that discriminates the journaling agent module 142 and is a connection ID.

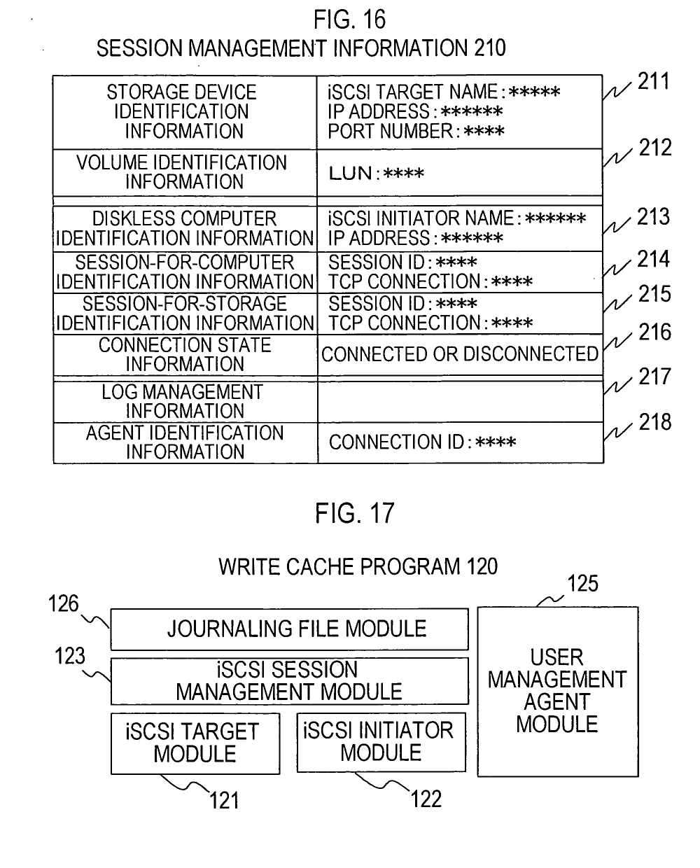

FIG. 17 is a diagram for describing the module configuration of the write cache program 120 which is started in the node device 104 of the second embodiment according to the present invention. As shown in the drawing, in the write cache program 120 of the embodiment, a journaling file module 126 which is the journaling file system is provided instead of the data management module 124.

In the node device 104, a CPU 111 registers the log showing metadata and the updated contents of the data block based on the log starting request and the log registration request received from the journaling agent module 142 of the diskless computer 101 in accordance with the journaling file module 126. Moreover, it periodically executes log flash. More specifically, it specifies the metadata and the updated contents of the data block recorded in the log of the write object. The CPU 111 creates an iSCSI write request packet based on the specified updated information in accordance with the iSCSI initiator module 122, sends it to an iSCSI target, and receives an iSCSI write response packet thereto. Furthermore, the CPU 111 sends a packet including the result shown in the iSCSI write response packet to the journaling agent module 142 of the diskless computer 101 in accordance with the journaling file module 126.

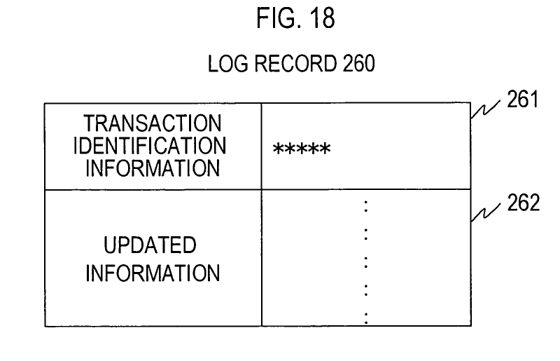

FIG. 18 is a diagram illustrating the exemplary configuration of a log record 260 created by the CPU 111 in accordance with the journaling file module 126. As shown in the drawing, the log record includes transaction identification information 261 which represents the correlation between the log records 260, and updated information 262 which is the meta contents and data information of the file system.

(3) Details of the System Operation

When the diskless computer 101 is powered ON, basically the same operation as that in the first embodiment is performed (see FIG. 2). Therefore, the same processes are also performed in the embodiment as the user authentication process in (6-1), the iSCSI session connecting process in (6-2), and the data block write process in (6-3) described in the first embodiment. Furthermore, when the OS of the diskless computer 101 is terminated, the same process is performed as the iSCSI session disconnecting process in (6-4) described in the first embodiment. Hereinafter, the points different from the first embodiment will be described.

(3-1) User Authentication Process

It is the same as the user authentication process in (6-1) described in the first embodiment.

(3-2) iSCSI Session Connecting Process

It is basically the same as the iSCSI session connecting process in (6-2) described in the first embodiment. However, in the step of updating the session management information 210 (S430 in FIG. 10B), the process is added in which the location to store the log record (a file) on a memory 112 and/or a storage unit 113, and is registered as log management information 217 into the session management information 210.

(3-2′) Log Starting Process

In the embodiment, after the iSCSI session connecting process is ended, the CPU 1011 issues the log starting request in accordance with the file module 143 in the diskless computer 101. On this account, the log starting process shown below is added in the embodiment.

In the diskless computer 101, the CPU 1011 issues the log starting request in accordance with the file module 143, creates a log starting request packet in association with the log starting request in accordance with the journaling agent module 142, and sends it to the node device 104. The information of the storage device 102 and the volume (the iSCSI target name, the IP address of the storage router, the port number, and the LUN) having been registered into the OS management domain in accordance with the iSCSI driver are additionally added to the log starting request packet.

In the node device 104, when the CPU 111 receives the log starting request packet from the diskless computer 101 through the communication control unit 114a, it executes the log starting means in accordance with the journaling file module 126, and starts to register the log record 260. Furthermore, it selects the relevant session information 210 from the iSCSI target name, the IP address, the port number, and the LUN registered into the log starting request packet, and additionally registers the information (connection information) that discriminates the connection to the journaling agent module 142 into the agent identification information 218. Moreover, the CPU 111 creates a log starting response packet in accordance with the journaling file module 126, and sends it back to the journaling agent module 142 of the diskless computer 101.

(3-3) Data Block Write Process

(3-3-1) Data Caching Process

The data caching process of the embodiment is started by the CPU 1011 to issue a log registration request in accordance with the file module 143 in the diskless computer 101. More specifically, in the embodiment, the CPU 1011 sends a log registration request packet to the node device 104 in accordance with the journaling agent module 142 at S510 in FIG. 11A instead of the iSCSI write request packet. In addition, the log registration request packet includes the transaction identification information 261 that shows the correlation between the log records 260, and the updated information 262 that is the meta contents and the data information of the file system. Furthermore, at S511 and S512, the CPU 1011 receives a log registration response packet instead of receiving the write response packet in accordance with the journaling agent module 142, and determines the packet showing whether the registration is successful.

Furthermore, the operational flow of the node device 104 shown in FIG. 11B is altered as follows. More specifically, at S520, the CPU 111 receives the log registration request packet in accordance with the journaling file module 126, instead of the iSCSI write request packet. Moreover, at S521, the CPU 111 selects the session management information 210 in accordance with the journaling file module as similar to the manner in the first embodiment. Besides, at S522, the CPU 111 determines whether the log (the transaction identification information 261 and the updated information 262) stored in the log registration request can be cached in accordance with the journaling file module as similar to the manner in the first embodiment. Furthermore, at S524 and S525, the CPU 111 creates a log record 260 in accordance with the journaling file module instead of the cache record 230, and updates the target management information 220 based on the number of data blocks stored in the log record 260. Moreover, at S523 and S526, the CPU 111 creates a log registration response packet in accordance with the journaling file module 126 instead of the iSCSI write response packet, and sends it back to the journaling agent module 142 of the diskless computer 101.

(3-3-2) Data Flash Process

In the data flash process of the embodiment, the CPU 111 performs the same process as that of the data management module 124 in the first embodiment in accordance with the journaling file module 126. More specifically, in the embodiment, at S613 to S615 in FIG. 12, the CPU 111 creates an iSCSI write request packet from the log record 260 in accordance with the log flash means of the journaling file module 126, and sends it to the volume of the storage device 102. Furthermore, at S619, it deletes all the log records 260 where the transaction identification information 261 is matched, only when the records are normally written.

(3-4) iSCSI Session Disconnecting Process

It is the same as the iSCSI session disconnecting process in (6-4) described in the first embodiment.

As described above, the second embodiment according to the present invention has been described.

In the embodiment, even when the diskless computer 101 is abnormally terminated, the log record 260 left in the node device 104 is written into the storage device 102, and thus the file system can be restored. Furthermore, even when the node device 104 is abnormally terminated, the session management information 210 and the log record 260 are restored to restart the data flash process as similar to the first embodiment.

In addition, the present invention is not limited to the embodiments, which can be modified variously within the scope of the teachings.

For example, in the embodiments above, in the data flash process, the target management information 220 where the record volume 225 exceeds a predetermined volume, or the target management information 220 over the data flash execution cycle time is detected, and the volume of the storage device 102 specified by the detected target management information 220 is determined as the target volume for data flash (see S610 and S611 in FIG. 12). However, it is acceptable that the detected target management information 220 is not adopted to determine the target volume when the iSCSI response time shown by the load state information 224 included in the detected target management information 220 is longer than a given threshold value. When this is done, it can be suppressed that the storage device 102 with a high load state and/or the load of the TCP connection is further increased to deteriorate or decay communication quality. In addition, when this is done, the data flash process for the volume of the storage device 102 specified by the target management information 220 where the iSCSI response time shown by the load state information 224 is longer than a given threshold value is to be executed in accordance with the data flash request packet from the user management server 106.

Furthermore, in the embodiments above, the example is taken and described that the present invention is applied to the router device disposed between the IP network 105a connected to the diskless computer 101 and the IP network 105b connected to the storage router 107 (the storage device 102). However, the invention is not limited thereto. For example, a write cache device according to the invention (an apparatus which executes the write cache program) may be formed separately from the router and disposed on the IP network 105a. Then, when starting, the diskless computer 101 may obtain the IP address of the write cache device from the DHCP server 103a, the write cache device may be set in a proxy unit, for example, and sending and receiving the iSCSI packet between the diskless computer 101 and the storage router 107 (the storage device 102) may be executed through the write cache device.

Moreover, in the embodiments above, the example is taken and described that IP is used as the network communication protocol between the diskless computer and the storage router and iSCSI is used as the upper protocol of the network communication protocol, but the present invention is not limited thereto.

As described above, according to the node device of the present invention, the write request from the diskless computer is cached, and the packet of write end is sent to the source of the packet. Therefore, the diskless computer can end the write request with no influence of the storage device and the network of the storage device. Furthermore, according to the administrative server of the present invention, when data to be written into the storage device available for the user is cached in the node device in user authentication, the write request for the data is sent to the node device and the data cached in the storage device is written. Thus, the data cached in the node device that remains unwritten into the storage device because of disconnected connection, for example, can be written into the storage device.

1. A node device which passes on information sent and received between at least one diskless computer and at least one storage device, the node device comprising:
cache means which caches target data of a write request, and sends a response to the write request to a source diskless computer of the write request, when information sent from the diskless computer is the write request to a storage device; and
flash means which sends the write request for the data having been cached in the cache means to a storage device into which the data is written, and receives a response to the write request from the storage device.

2. The node device according to claim 1, further comprising management means which manages a session between individual diskless computers and individual storage devices,
wherein the flash means sends a write request for the data having been cached by the cache means to a storage device having a session with a source of the data.

3. The node device according to claim 2, wherein
the management means manages a cache volume of data to be written into a storage device at each of the storage devices, and
the flash means sends a write request for the data having been cached by the cache means to be written into a storage device to a storage device having a cache volume exceeding a given value.

4. The node device according to claim 3, wherein
when a cache volume of data with respect to a destination storage device of the write request having been received from the diskless computer exceeds a given value, the cache means suspends a response to the write request for a fixed time.

5. The node device according to claim 2, wherein
the management means manages current send time of a write request to a storage device at each of the storage devices, and
the flash means sends a write request for the data having been cached by the cache means to be written into a storage device to a storage device over a given time from the current send time.

6. The node device according to claim 2, wherein
the management means manages a connection state of a session at each of sessions, and
the flash means suppresses transmission of a write request to a storage device with a disconnected connection state.

7. The node device according to claim 2, wherein
the management means manages a network between a storage device and a node device having a session and a load state of the storage device at each of sessions, and
the flash means suppresses transmission of a write request to a storage device having a load state exceeding a given value.

8. The node device according to claim 1, wherein
the cache means associates the write request having been sent from a diskless computer with a destination storage device of the write request, and records it as a log record into a recording medium, and
the flash means creates a write request to the storage device based on the log record stored in the recording medium as the log record is associated with the storage device.

9. The node device according to claim 1, wherein
the cache means records updated contents of data of a file system operating on a diskless computer into a recording medium in association with a storage device in which data is to be updated, and
the flash means creates a write request to the storage device based on the updated contents of data stored in the recording medium in association with the storage device.

10. An administrative server which determines whether a user of a diskless computer is allowed to use a storage device through the node device according to claim 1,
the administrative server comprising:
administrative information storing means which stores user management information at each of users, the information including authentication information about the user, identification information about a storage device available for the user, and identification information about a node device used by the user of the diskless computer when the user has used the storage device; and
user authentication means which authenticates the user of the diskless computer by searching for the user management information including the user authentication information contained in a user authentication request received from the diskless computer through the node device from the administrative information storing means,
wherein, in the case where user management information including user authentication information that is contained in the user authentication request is stored in the administrative information storing means, when node device identification information is contained in the user management information, the user authentication means allows the node device which is specified by the node device identification information to send a write request for data to be written into a storage device specified by storage device identification information of the user management information being cached in the node device, and updates node device identification information of the user management information to identification information about the node device having passed on the user authentication request.

11. A computer readable program which passes on information sent and received between at least one diskless computer and at least one storage device,
wherein, the program allows a computer to function as:
cache means which caches target data of a write request, and sends a response to the write request to a source diskless computer of the write request when information sent from the diskless computer is the write request to a storage device; and
flash means which sends a write request for the data having been cached in the cache means to a storage device into which the data is written, and receives a response to the write request from the storage device.

12. A computer readable program which determines whether a user of a diskless computer uses a storage device through a node device having: cache means which caches target data of a write request, and sends a response to the write request to a source diskless computer of the write request when information sent from the diskless computer is the write request to a storage device; and flash means which sends a write request for the data having been cached in the cache means to a storage device into which the data is written, and receives a response to the write request from the storage device,
wherein the program allows a computer to function as:
administrative information storing means which stores user management information at each of users, the information including authentication information about the user, identification information about a storage device available for the user, and identification information about a node device used by the user of the diskless computer when the user used the storage device; and
user authentication means which authenticates the user of the diskless computer by searching for the user management information including the user authentication information contained in a user authentication request received from the diskless computer through the node device from the administrative information storing means,
wherein in the case where user management information including user authentication information that is contained in the user authentication request is stored in the administrative information storing means, when node device identification information is contained in the user management information, the user authentication means allows the node device which is specified by the node device identification information to send a write request for data to be written into a storage device specified by storage device identification information of the user management information being cached in the node device, and updates node device identification information of the user management information to identification information about the node device having passed on the user authentication request.

13. A routing method which passes on information sent and received between at least one diskless computer and at least one storage device, the routing method comprising the steps of:
caching target data of a write request, and sending a response to the write request to a source diskless computer of the write request when information sent from the diskless computer is the write request to a storage device; and
sending a write request for the data having been cached in the cache means to a storage device into which the data is written, and receiving a response to the write request from the storage device.

14. An authentication method which determines whether a user of a diskless computer to allowed to use a storage device through a node device having: cache means which caches target data of a write request, and sends a response to the write request to a source diskless computer of the write request when information sent from the diskless computer is the write request to a storage device; and flash means which sends a write request for the data having been cached in the cache means to a storage device into which the data is written, and receives a response to the write request from the storage device,
the authentication method comprising the steps of:
authenticating a user of a diskless computer by searching for user management information including user authentication information contained in a user authentication request received from the diskless computer through the node device from administrative information storing means which stores user management information at each of users, the information including authentication information about the user, identification information about a storage device available for the user, and identification information about a node device used by the user of the diskless computer when the user used the storage device; and
in the case where user management information including user authentication information that is contained in the user authentication request is stored in the administrative information storing means, when node device identification information is contained in the user management information, allowing the node device which is specified by the node device identification information to send a write request for data to be written into a storage device specified by storage device identification information of the user management information being cached in the node device, and updating node device identification information of the user management information into identification information about the node device having passed on the user authentication request.
